(19) United States
(12) Patent Application Publication
(10) Pub. No.: US 2005/0194713 A1
(43) Pub. Date: Sep. 8, 2005

(54) Method of making a molded article

(76) Inventors: John Erickson, Southgate, MI (US); Dan Wilson, New Boston, MI (US); Heinz Plaumann, Flat Rock, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/747,639

(22) Filed: Dec. 29, 2003

(51) Int. Cl. B28B 7/22

(52) U.S. Cl. 264/255

(57) ABSTRACT

The subject invention provides a method of making a molded article (10). The molded article (10) includes a paint layer (12) formed from a paint composition and a polyurethane layer (14) formed from an isocyanate component and an isocyanate-reactive component. The paint composition is applied to a surface (22) of a mold (18, 20) to form the paint layer (12). The paint layer (12) is infused with a base. The polyurethane layer (14) is then adhered to the paint layer (12) in the mold (18, 20) to make the molded article (10). The base promotes adhesion between the paint layer and polyurethane layer of the article by catalyzing a reaction between the isocyanate component in the polyurethane layer (14) and the paint component

### BACKGROUND OF THE INVENTION

1) Field of the Invention

The subject invention generally relates to a method of making a molded article and improving adhesion between layers in a molded article. More specifically, the subject invention relates to a method of improving adhesion between a paint layer and a polyurethane layer in the molded article.

2) Description of Related Art

Methods of making molded articles are known in the art. The relevant molded articles include a paint layer and a polyurethane layer.

The methods include a first step of applying a mold release agent to a surface of a mold. The mold release agent inhibits the paint layer from adhering to the surface of the mold. A paint composition is then applied to the surface of the mold to form the paint layer. Finally, the polyurethane layer is adhered to the paint layer in the mold such that the molded articles, when removed from the mold, include the polyurethane layer adhered to the paint layer and require no further painting.

One of the difficulties encountered in the prior art methods is that the paint layer does not properly adhere to the polyurethane layer, resulting in delamination of the paint layer from the polyurethane layer, which usually occurs during demolding of the molded articles from the mold. Furthermore, the molded articles that retain the paint layer during demolding are susceptible to delamination during further processing or use, as shown in Example 1 below.

One reason for the delamination of the paint layer from the polyurethane layer is that the methods of the prior art do not include infusing the paint layer with a base. Thus, there is no catalysis of a reaction between an isocyanate component in the polyurethane layer and the paint component to increase the adhesion between the polyurethane layer and the paint layer. As such, there exists an opportunity for increasing the adhesion of the paint layer to the polyurethane layer in the molded articles.

### BRIEF SUMMARY OF THE INVENTION

The subject invention provides a method of making a molded article. The molded article includes a paint layer and a polyurethane layer.

The method includes applying a paint composition to a surface of a mold to form the paint layer. The paint layer is infused with a base. The polyurethane layer is adhered to the paint layer in the mold.

The base catalyzes a reaction between an isocyanate component in the polyurethane layer and the paint component to increase the adhesion between the paint layer and the polyurethane layer. Due to the infusion of the paint layer with the base, the adhesion between the polyurethane layer and the paint layer is sufficient to prevent delamination of the paint layer from the polyurethane layer during demolding of the article from the mold. Furthermore, the adhesion between the paint layer and the polyurethane layer is sufficient for the paint layer to resist delamination during further processing or use.

### BRIEF DESCRIPTION OF THE SEVERAL VIEWS OF THE DRAWING

Other advantages of the present invention will be readily appreciated as the same becomes better understood by reference to the following detailed description when considered in connection with the accompanying drawings wherein:

FIG. 1 is a perspective view of a molded article, specifically an instrument panel for an automobile, made according to the method of the subject invention;

FIG. 2 is a cross-sectional view of section 2-2 of FIG. 1;

FIG. 3 is a cross-sectional view of another embodiment of the molded article;

FIG. 4 is a cross-sectional view of an open mold; and

FIG. 5 is a cross-sectional view of a closed mold.

### DETAILED DESCRIPTION OF A PREFERRED EMBODIMENT

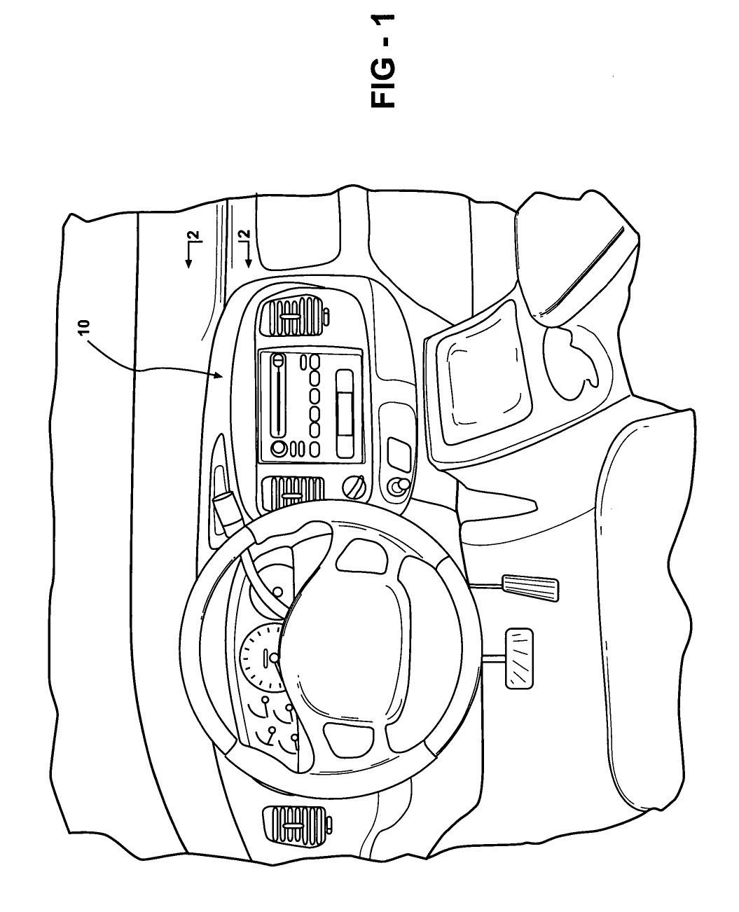

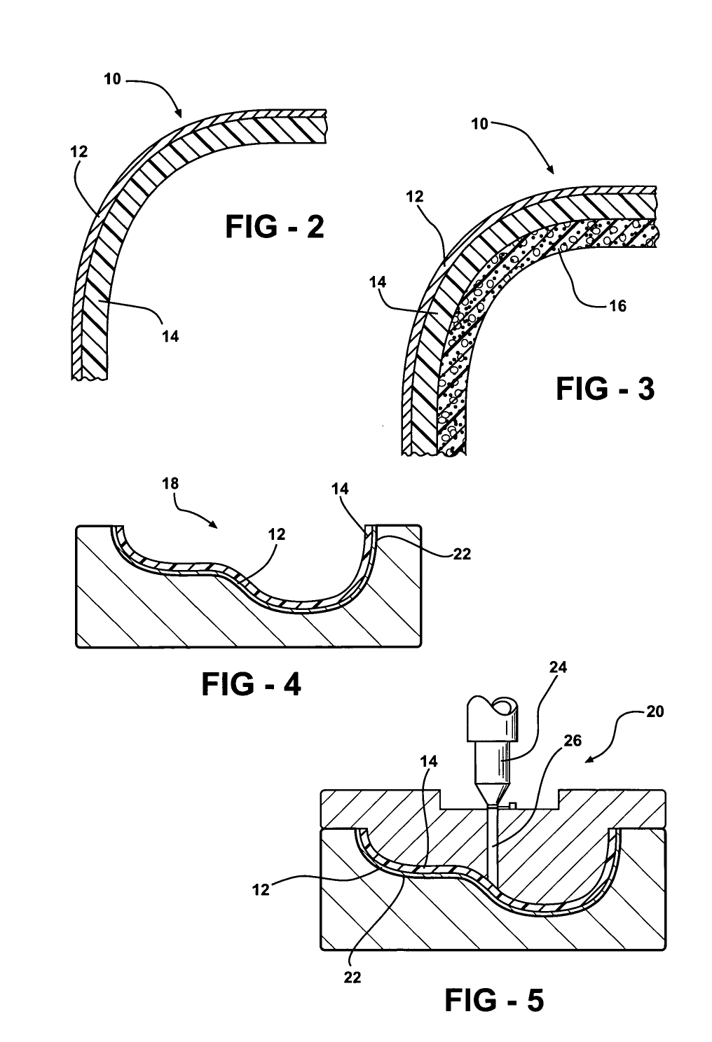

Referring to the Figures, wherein like numerals indicate like or corresponding parts throughout the several views, a method of making a molded article 10 is proposed. Referring to FIG. 1, the molded article 10 of the subject invention is an instrument panel in an automobile. However, it is to be appreciated that the molded article 10 may be any variety of products, as are known in the art. Referring to FIG. 2, the molded article 10 includes a paint layer 12 and a polyurethane layer 14. Preferably, the polyurethane layer 14 is non-foamed, as opposed to foamed, for promoting adhesion of the polyurethane layer 14 to the paint layer 12. However, the polyurethane layer 14 may be foamed. In another embodiment, the molded article 10 may also include an additional polyurethane foam layer 16, as shown in FIG. 3.

The molded articles 10 may be made in any type of mold that is used for making molded articles 10. In one embodiment, as shown in FIG. 4, the molded articles 10 may be made in an open mold 18. In another embodiment, as shown in FIG. 5, the molded articles 10 may be made in a closed mold 20. It is to be understood that the open mold 18 refers to either the open mold 18 as shown in FIG. 4 or the closed mold 20 as shown in FIG. 5 when the closed mold 20 is in an open position. Preferably, the molds 18, 20 are heated to a temperature that is sufficient to cure a surface of the polyurethane layer 14. Preferably, the molds 18, 20 are heated to a temperature of at least 145° F. More preferably, the molds 18, 20 are heated to a temperature of between 145° F. and 165° F. The methods of making the molded articles 10 in the respective molds 18, 20 are further discussed below.

Preferably, the method includes a first step of applying a mold release agent to a surface 22 of the mold 18, 20. The mold release agent inhibits the paint layer 12 from adhering to the surface 22 of the mold 18, 20. The mold release agent may be of any variety of mold release agents, as are well known in the art. Preferably, the mold release agent is RCTW 13091, a water-soluble wax-based mold release agent commercially available from Chemtrend. In one embodiment, the mold release agent may be sprayed onto the surface 22 of the mold 18, 20. In another embodiment, the mold release agent may be included in a paint composition. In another embodiment, an internal mold release system may be employed that remains on the surface 22 of the mold 18, 20 after molding each molded article 10. Such methods of applying the mold release agent are known in the art.

The method further includes the step of applying the paint composition to the surface 22 of the mold 18, 20, over the mold release agent, to form the paint layer 12. Preferably, the paint composition includes a water-based latex composition, commercially available from Redspot Paint & Varnish Company, which is commonly used in automotive applications. In another embodiment, the paint composition may include a urethane-based composition, an acrylic-based composition, a vinyl-based composition, or any other type of paint composition commonly used to form the paint layer 12.

Preferably, the paint composition is applied to the surface 22 of the open mold 18. By applying the paint composition to the surface 22 of the open mold 18, the molded article 10 may be made in complex shapes while maintaining the quality of the paint layer 12. The paint composition may be applied to the surface 22 of the mold 18, 20 through a number of methods, all of which are known in the art, to form the paint layer 12. Preferably, the paint composition is sprayed onto the surface 22 of the open mold 18 such that the paint layer 12 is substantially uniform over the surface 22 of the open mold 18.

The next step is infusing the paint layer 12 with the base. By infusing, it is meant that the base mixes at least partially with the paint composition. Preferably, the base includes a metal selected from the group of alkali metals, alkaline earth metals, and mixtures thereof, which are known as catalysts for urethane reactions. More preferably, the base is selected from the group of potassium hydroxide, sodium hydroxide, lithium hydroxide, and combinations thereof, which are effective bases including the preferred metals. Most preferably, the base is potassium hydroxide, which is sufficiently non-volatile to include in the paint layer.

Preferably, a light, uniform coat of the base is sprayed onto the paint layer 12 to disperse the base on the paint layer 12. The base infuses into the paint composition in the mold 18, 20. More preferably, a light, uniform coat of a solution including at least 0.2 parts by weight of the base, based on 100 parts by weight of the solution, is sprayed onto the paint layer 12, which is sufficient to increase the adhesion in the molded article 10. Most preferably, the solution includes from 0.2 to 2 parts by weight of the base, based on 100 parts by weight of the solution, which is less corrosive, as compared to higher concentrations of the base in the solution, yet is still sufficient to increase the adhesion in the molded article 10. In another embodiment, the base is mixed into the paint composition prior to the step of applying the paint composition to the surface 22 of the mold 18. Preferably, at least 0.2 parts by weight of the base, based on 100 parts by weight of the paint composition, is mixed into the paint composition, which is sufficient to increase the adhesion in the molded article 10. More preferably, as with spraying the solution including the base onto the paint layer 12, from 0.2 to 2 parts by weight of the base, based on 100 parts by weight of the paint composition, is mixed into the paint composition.

The polyurethane layer 14 is then adhered to the paint layer 12 in the mold 18, 20 such that the molded article 10 includes the paint layer 12 when demolded from the mold 18, 20. The polyurethane layer 14 includes the isocyanate component and an isocyanate-reactive component. The isocyanate component may be any isocyanate component used for forming the polyurethane layer 14, as are known in the art, including aromatic or aliphatic isocyanate components. Preferably, the isocyanate component is Elastoskin® R 51330T Isocyanate, commercially available from BASF Corporation. In one embodiment, the isocyanate-reactive component is a polyol including reactive hydroxyl groups. The polyol may be of any variety or combination of polyols as are known in the art. Preferably, the isocyanate-reactive component is Elastoskin® R 51330R Resin, commercially available from BASF Corporation. In another embodiment, the isocyanate-reactive component may include reactive amine groups. The isocyanate component and the isocyanate-reactive component may be varied in type and amount based on desired characteristics of the polyurethane layer 14. Preferably, the polyurethane layer 14 includes an isocyanate index of at least 65, i.e., a ratio of isocyanate groups in the isocyanate component to hydroxyl groups or amine groups in the isocyanate-reactive component, to ensure that excess isocyanate groups are available. More preferably, the isocyanate index is from 65 to 250 for forming the polyurethane layer 14 ranging from a soft urethane, formed at the isocyanate index of 65, to a rigid trimer urethane, formed at the isocyanate index of 250. Most preferably, the isocyanate index is from 95 to 105 for forming the polyurethane layer 14.

Preferably, the polyurethane layer 14 is sprayed onto the paint layer 12 into which the base has been infused. A reaction is allowed to take place between the isocyanate component in the polyurethane layer 14 and the paint composition to increase the adhesion between the paint layer 12 and the polyurethane layer 14. More specifically, the open mold 18 is preferably closed to produce the closed mold 20 prior to adhering the polyurethane layer 14 to the paint layer 12. However, it is to be appreciated that the polyurethane layer 14 may be adhered to the paint layer 12 in the open mold 18. Preferably, the polyurethane layer 14 is adhered to the paint layer 12 through reaction injection molding (RIM) the polyurethane layer 14 onto the paint layer into which the base has been infused. RIM includes mixing the isocyanate component and the isocyanate-reactive component to form a polyurethane composition. The polyurethane composition is then applied onto the paint layer, thereby forming the polyurethane layer 14.

In one embodiment, as shown in FIG. 5, the isocyanate component and the isocyanate-reactive component are mixed outside of the mold 18, 20 to form the polyurethane layer 14. Preferably, the isocyanate component and the isocyanate-reactive component are mixed at a temperature of from 70° F. to 190° F. for promoting a reaction between the isocyanate component and the isocyanate-reactive component. More preferably, the isocyanate component and the isocyanate-reactive component are mixed at a temperature of 100° F. to ensure reaction of the isocyanate component and the isocyanate-reactive component. A mixing head 24 is disposed adjacent to the closed mold 20 to mix the isocyanate component and the isocyanate-reactive component. The mixing ensures uniform reaction of the isocyanate component and the isocyanate-reactive component. The polyurethane layer 14 is then injected into the closed mold 20 and onto the paint layer 12, thereby forming the polyurethane layer 14. More specifically, the polyurethane layer 14 is supplied through a channel 26 from the mixing head 24 into the closed mold 20. The molded article 10 is maintained in the closed mold 20 for an amount of time sufficient for the isocyanate component and the isocyanate-reactive component to react, preferably for a period of at least 20 seconds such that the polyurethane layer 14 is sufficiently formed. More preferably, the molded article 10 is maintained in the closed mold 20 for a period of from 20 seconds to 4 minutes.

In another embodiment, the isocyanate component and the isocyanate-reactive component are mixed in the closed mold 20 to form the polyurethane composition in the closed mold 20. The polyurethane composition is applied onto the paint layer 12, thereby forming the polyurethane layer 14. The polyurethane layer 14 is adhered to the paint layer 12 as the polyurethane layer 14 is formed.

The adhesion between the paint layer 12 and the polyurethane layer 14 is increased, as shown below in the Examples below, as a result of the presence of the base in the paint layer 12. More specifically, hydroxide groups in the base, by creating a basic environment between the paint layer 12 and the polyurethane layer 14, allow a reaction to take place between the isocyanate component in the polyurethane layer 14 and the paint composition to increase the adhesion between the paint layer 12 and the polyurethane layer 14. The increased adhesion both prevents delamination of the paint layer 12 from the polyurethane layer 14 as the molded article 10 is being demolded from the mold 18, 20, and further inhibits delamination of the paint layer 12 from the polyurethane layer 14 over time as the molded article 10 is further processed and used. As further discussed in the examples, visual observations of the paint layer 12, based on the appearance of the paint layer 12 after demolding, were used to evaluate the adhesion of the polyurethane layer 14 to the paint layer 12. A scratch test was used to evaluate the adhesion of the paint layer 12 under conditions that the molded article 10 will likely be exposed to over time.

### EXAMPLE 1

Molded articles are made according to prior art methods as a benchmark for comparison to molded articles made according to the subject invention, to be introduced in further examples below. An open mold is heated to a temperature of 145° F. RCTW 13091, a water-soluble wax-based mold release agent commercially available from Chemtrend, is sprayed onto a surface of the open mold. 458W, a water-based latex paint composition commercially available from Redspot Paint & Varnish Company, is sprayed onto the surface of the open mold, over the mold release agent, to form a paint layer. The open mold is then closed to produce a closed mold. A polyurethane composition is prepared outside of the closed mold at a temperature of 100° F. by mixing an isocyanate component comprising Elastoskin® R 51330T Isocyanate and an isocyanate-reactive component comprising Elastoskin® R 51330R Resin to form a polyurethane composition at an isocyanate index of 105. The polyurethane composition is introduced into the closed mold via reaction injection molding (RIM), wherein the isocyanate component and the isocyanate-reactive component are mixed in a mixing chamber outside of the mold. The polyurethane composition is then injected through a channel into the closed mold and onto the paint layer, thereby forming a polyurethane layer, which adheres to the paint layer. The molded article is retained in the mold for a period of 45 seconds before demolding. The same procedure is performed with the mold at temperatures of 155° F. and 165° F. Two molded articles are made at each temperature.

Visual observations of the paint layer after demolding are used to evaluate adhesion between the polyurethane layer to the paint layer. The samples are examined to determine if the paint layer is peeling or bubbling from the polyurethane layer. A scratch test is performed to determine how well the paint layer resists delamination after demolding, so long as the paint layer appears to be satisfactory after demolding. The scratch test is performed using a razor blade or a finger nail to scratch the paint layer after the molded article is allowed to cool. A measurement of resistance to scratching is recorded based on the relative ease with which the paint layer is scratched off of the polyurethane layer.

Referring to Table 1, the paint layer in the molded articles made with the mold at 145° F. was peeling and bubbling from the polyurethane layer upon demolding the molded article from the mold. A scratch test was not used for these samples. The paint layer in the molded articles made with the mold at 155° F. appeared satisfactory upon demolding. The scratch test resulted in easy scratching of the paint layer from the polyurethane layer. The paint layer in the molded articles made with the mold at 165° F. also appeared satisfactory upon demolding. The scratch test resulted in more difficult scratching of the paint layer from the polyurethane layer than for the molded articles made with the mold at 155° F., however, the paint layer was still easily scratched off of the polyurethane layer.

### EXAMPLE 2

Molded articles are made according to the method of the subject invention. The molded articles are prepared through the same steps and the same materials as the molded articles in Example 1, the only difference being that a light, uniform coat of a solution including 1 part by weight of potassium hydroxide, based on 100 parts by weight of the solution, is sprayed onto the paint layer prior to applying the polyurethane layer for increasing the adhesion of the paint layer to the polyurethane layer, as compared to the molded articles made in Example 1.

The same tests as performed in Example 1 were used to evaluate the adhesion between the polyurethane layer to the paint layer in the molded articles. Referring to Table 1, the paint layer in the molded articles made with the mold at 145° F. was not completely dry after demolding the molded articles from the mold. A scratch test was not used for these samples. The paint layer in the molded articles made with the mold at 155° F. also appeared satisfactory upon demolding. The scratch test resulted in difficult scratching of the paint layer from the polyurethane layer, as compared to the scratch test results of the molded articles made in Example 1. The paint layer in the molded articles made at 165° F. also appeared satisfactory upon demolding. The scratch test resulted in very difficult scratching of the paint layer from the polyurethane layer, as compared to the scratch test results of the molded articles made with the mold at 155° F. and the molded articles made in Example 1, thus illustrating increased adhesion of the paint layer to the polyurethane layer.

### EXAMPLE 3

Molded articles are made similar to the molded articles made in Example 2, the difference being that a light, uniform coat of a solution including 1 part by weight of potassium chloride, based on 100 parts by weight of the solution, is substituted for the solution including potassium hydroxide. Referring to Table 1, the adhesion between the polyurethane layer and the paint layer, as evaluated through the same tests as performed in Examples 1 and 2, was the same as for the molded articles of Example 1. There was no increase in adhesion between the paint layer and the polyurethane layer when the potassium chloride solution was sprayed onto the paint layer, showing that the potassium chloride had no effect on the adhesion between the polyurethane layer and the paint layer.

TABLE 1

| | | | | | Example 3 | |
|---|---|---|---|---|---|---|
| | Example 1 (Prior Art) | | Example 2 | | | Scratch |
| Temp., ° F. | Demolding | Scratch Test | Demolding | Scratch Test | Demolding | Test |
| 145 | Pealing/ | None | Wet | None | Pealing/ | None |
| | Bubbling | | | | Bubbling | |
| 155 | Satisfactory | Easy | Satisfactory | Difficult | Satisfactory | Easy |
| 165 | Satisfactory | More Difficul [symbol] | Satisfactory | Very Difficul [symbol] | Satisfactory | Moderate |

Thus as shown through the examples, the adhesion between the polyurethane layer and the paint layer in the molded articles is increased by infusing the paint layer with the potassium hydroxide. The ineffectiveness of potassium chloride, which is known as a source of potassium, proves that the basic properties of the potassium hydroxide account for the increased adhesion. The ineffectiveness of potassium chloride is further evidence that bases similar to potassium hydroxide will result in a similar increase in adhesion between the polyurethane layer and the paint layer.

Obviously, many modifications and variations of the present invention are possible in light of the above teachings. The invention may be practiced otherwise than as specifically described within the scope of the appended claims. In addition, the reference numerals in the claims are merely for convenience and are not to be read in any way as limiting.

1. A method of making a molded article (10), wherein the molded article (10) comprises a paint layer (12) and a polyurethane layer (14), said method comprising the steps of:
applying a paint composition to a surface (22) of a mold (18, 20) to form the paint layer (12);
infusing the paint layer (12) with a base; and
adhering the polyurethane layer (14) to the paint layer (12).

2. A method as set forth in claim 1 wherein the base includes a metal selected from the group of alkali metals, alkaline earth metals, and mixtures thereof.

3. A method as set forth in claim 2 wherein the base is selected from the group of potassium hydroxide, sodium hydroxide, lithium hydroxide, and mixtures thereof.

4. A method as set forth in claim 1 wherein the step of infusing the paint layer (12) with the base is further defined as infusing the paint layer (12) with at least 0.2 parts by weight of the base, based on 100 parts by weight of the paint composition.

5. A method as set forth in claim 4 wherein the step of infusing the paint layer (12) with the base is further defined as mixing the base into the paint composition prior to applying the paint composition to the surface (22) of the mold (18, 20).

6. A method as set forth in claim 4 wherein the step of infusing the paint layer (12) with the base is further defined as spraying the base onto the paint layer (12) prior to said step of adhering the polyurethane layer (14) to the paint layer (12).

7. A method as set forth in claim 6 wherein the step of spraying the base onto the paint layer (12) is further defined as spraying a solution including at least 0.2 parts by weight of the base, based on 100 parts by weight of the solution, onto the paint layer (12).

8. A method as set forth in claim 1 wherein the paint composition comprises a water-based latex composition.

9. A method as set forth in claim 1 wherein the paint composition comprises a urethane-based composition.

10. A method as set forth in claim 1 wherein the paint composition comprises an acrylic-based composition.

11. A method as set forth in claim 1 wherein the paint composition comprises a vinyl-based composition.

12. A method as set forth in claim 1 further comprising the step of applying a mold release agent to the surface (22) of the mold (18, 20) prior to said step of applying the paint composition to the surface (22) of the mold (18, 20).

13. A method as set forth in claim 1 wherein the step of adhering the polyurethane layer (14) is further defined as spraying the polyurethane layer (14) onto the paint layer (12) into which the base has been infused and allowing a reaction to take place between an isocyanate component in the polyurethane layer (14) and the paint composition to increase the adhesion between the paint layer (12) and the polyurethane layer (14).

14. A method as set forth in claim 1 further comprising the steps of mixing an isocyanate component and an isocyanate-reactive component outside of the open mold (18) to form a polyurethane composition and applying said polyurethane composition to the paint layer (12), thereby forming the polyurethane layer (14).

15. A method as set forth in claim 1 further comprising the steps of mixing an isocyanate component and an isocyanate-reactive component in the open mold (18) to form a polyurethane composition and applying said polyurethane composition to the paint layer (12), thereby forming the polyurethane layer (14).

16. A method as set forth in claim 1 wherein the step of applying the paint composition is further defined as applying the paint composition to the surface (22) of an open mold (18).

17. A method as set forth in claim 16 further comprising the step of closing the open mold (18) to produce a closed mold (20) prior to said step of adhering the polyurethane layer (14) to the paint layer (12).

18. A method as set forth in claim 17 wherein the step of adhering the polyurethane layer (14) to the paint layer (12) is further defined as reaction injection molding the polyurethane layer (14) onto the paint layer (12) into which the base has been infused and allowing a reaction to take place between an isocyanate component in the polyurethane layer (14) and the paint composition to increase the adhesion between the paint layer (12) and the polyurethane layer (14).

19. A method as set forth in claim 18 wherein the step of reaction injection molding the polyurethane layer (14) is further defined as mixing an isocyanate component and an isocyanate-reactive component outside of the closed mold (20) to form a polyurethane composition and injecting the polyurethane composition into the closed mold (20) and onto the paint layer (12), thereby forming the polyurethane layer (14).

20. A method as set forth in claim 18 wherein the step of reaction injection molding the polyurethane layer (14) is further defined as mixing an isocyanate component and an isocyanate-reactive component in the closed mold (20) to form a polyurethane composition in the closed mold (20) and applying the polyurethane composition onto the paint layer (12), thereby forming the polyurethane layer (14).

21. A method as set forth in claim 1 further comprising the step of heating the mold (18, 20) to a temperature of at least 145° F.

22. A molded article (10) made according to the method as set forth in claim 1.

23. A method of increasing adhesion between layers of a molded article (10), wherein the molded article (10) comprises a paint layer (12) and a polyurethane layer (14), said method comprising the steps of:
applying a paint composition comprising a water-based latex composition to a surface (22) of an open mold (18) to form the paint layer (12);
spraying an alkali metal hydroxide solution onto the paint layer (12);
adhering the polyurethane layer (14) to the paint layer (12) in the mold (20).

24. A method as set forth in claim 23 wherein the alkali metal hydroxide solution comprises potassium hydroxide.

25. A method as set forth in claim 23 wherein the step of spraying the alkali metal hydroxide solution onto the paint layer (12) is further defined as spraying a solution including at least 0.2 parts by weight of potassium hydroxide, based on 100 parts by weight of the solution, onto the paint layer (12).

26. A method as set forth in claim 23 further comprising the step of applying a mold release agent to the surface (22) of the open mold (18) prior to said step of applying the paint composition to the surface (22) of the mold (18).

27. A method as set forth in claim 23 further comprising the step of closing the open mold (18) to produce a closed mold (20) prior to said step of adhering the polyurethane layer (14) to the paint layer (12).

28. A method as set forth in claim 23 wherein the step of adhering the polyurethane layer (14) to the paint layer (12) is further defined as reaction injection molding the polyurethane layer (14) in the closed mold (20).

29. A method as set forth in claim 28 wherein the step of reaction injection molding the polyurethane layer (14) is further defined as mixing an isocyanate component and an isocyanate-reactive component outside of the closed mold (20) to form a polyurethane composition and injecting the polyurethane composition into the closed mold (20) and onto the paint layer (12), thereby forming the polyurethane layer (14).

30. A method as set forth in claim 28 wherein the step of reaction injection molding the polyurethane layer (14) is further defined as mixing an isocyanate component and an isocyanate-reactive component in the closed mold (20) to form a polyurethane composition in the closed mold (20) and applying the polyurethane composition onto the paint layer (12), thereby forming the polyurethane layer (14).

31. A method as set forth in claim 23 further comprising the step of heating the closed mold (20) to a temperature of at least 145° F.

32. The molded article (10) made according to the method as set forth in claim 23.

33. A method of increasing adhesion between layers of a molded article (10), wherein the molded article (10) comprises a paint layer (12) and a polyurethane layer (14), said method comprising the steps of:
mixing an alkali metal hydroxide solution into a paint composition comprising a water-based latex composition;
applying the paint composition to a surface (22) of an open mold (18) to form the paint layer (12);
adhering the polyurethane layer (14) to the paint layer (12) in the mold (20).

34. A method as set forth in claim 33 wherein the alkali metal hydroxide solution comprises potassium hydroxide.

35. A method as set forth in claim 33 wherein the step of mixing the alkali metal hydroxide solution into the paint composition is further defined as mixing at least 0.2 parts by weight of potassium hydroxide, based on 100 parts by weight of the solution, into the paint composition.

36. A method as set forth in claim 33 further comprising the step of applying a mold release agent to the surface (22) of the open mold (18) prior to said step of applying the paint composition to the surface (22) of the mold (18).

37. A method as set forth in claim 33 further comprising the step of closing the open mold (18) to produce a closed mold (20) prior to said step of adhering the polyurethane layer (14) to the paint layer (12).

38. A method as set forth in claim 33 wherein the step of adhering the polyurethane layer (14) to the paint layer (12) is further defined as reaction injection molding the polyurethane layer (14) in the closed mold (20).

39. A method as set forth in claim 38 wherein the step of reaction injection molding the polyurethane layer (14) is further defined as mixing an isocyanate component and an isocyanate-reactive component outside of the closed mold (20) to form a polyurethane composition and injecting the polyurethane composition into the closed mold (20) and onto the paint layer (12), thereby forming the polyurethane layer (14).

40. A method as set forth in claim 38 wherein the step of reaction injection molding the polyurethane layer (14) is further defined as mixing an isocyanate component and an isocyanate-reactive component in the closed mold (20) to form a polyurethane composition in the closed mold (20) and applying the polyurethane composition onto the paint layer (12), thereby forming the polyurethane layer (14).

41. A method as set forth in claim 33 further comprising the step of heating the closed mold (20) to a temperature of at least 145° F.

42. The molded article (10) made according to the method as set forth in claim 33.

43. A method of making a molded article (10), wherein the molded article (10) comprises a paint layer (12) and a polyurethane layer (14), said method comprising the steps of:
providing the paint layer (12);
infusing the paint layer (12) with a base; and
applying and adhering the polyurethane layer (14) to the paint layer (12).

44. A method as set forth in claim 43 wherein the step of providing the paint layer comprises applying a paint composition to a substrate to form the paint layer (12).

45. A method as set forth in claim 43 wherein the step of providing the paint layer comprises spraying a paint composition to a surface of a mold (22) to form the paint layer (12).

46. A method as set forth in claim 43 wherein the base includes a metal selected from the group of alkali metals, alkaline earth metals, and mixtures thereof.

47. A method as set forth in claim 46 wherein the base is selected from the group of potassium hydroxide, sodium hydroxide, lithium hydroxide, and mixtures thereof.

48. A method as set forth in claim 44 wherein the step of infusing the paint layer (12) with the base is further defined as infusing the paint layer (12) with at least 0.2 parts by weight of the base, based on 100 parts by weight of the paint composition.

49. A method as set forth in claim 48 wherein the step of infusing the paint layer (12) with the base is further defined as mixing the base into the paint composition prior to applying the paint composition to the surface (22) of the mold (18, 20).

50. A method as set forth in claim 48 wherein the step of infusing the paint layer (12) with the base is further defined as spraying the base onto the paint layer (12) prior to said step of applying and adhering the polyurethane layer (14) to the paint layer (12).

51. A method as set forth in claim 50 wherein the step of spraying the base onto the paint layer (12) is further defined as spraying a solution including at least 0.2 parts by weight of the base, based on 100 parts by weight of the solution, onto the paint layer (12).

52. A method as set forth in claim 44 wherein the paint composition comprises a water-based latex composition, a urethane-based composition, an acrylic-based composition or a vinyl-based composition.

53. A method as set forth in claim 45 further comprising the step of applying a mold release agent to the surface of the mold (22) prior to said step of applying the paint composition to the surface of the mold (22).

54. A method as set forth in claim 45 further comprising the step of heating the mold (18, 20) to a temperature of at least 145° F.

55. A molded article (10) made according to the method as set forth in claim 43.
